(19) United States
(12) Patent Application Publication
(10) Pub. No.: US 2026/0264662 A1
(43) Pub. Date: Sep. 10, 2026

(54) HYBRID ELECTRIC VEHICLE

(71) Applicant: TOYOTA JIDOSHA KABUSHIKI KAISHA, Toyota-shi (JP)

(72) Inventors: Taku HARADA, Nisshin-shi (JP); Yohei AGATSUMA, Nagoya-shi (JP); Manabu UEHARA, Miyoshi-shi (JP); Yuya AOKI, Miyoshi-shi (JP); Masaki HIRONAKA, Gamagori-shi (JP)

(73) Assignee: TOYOTA JIDOSHA KABUSHIKI KAISHA, Toyota-shi (JP)

(21) Appl. No.: 19/434,455

(22) Filed: Dec. 29, 2025

(30) Foreign Application Priority Data
Mar. 5, 2025 (JP) 2025-034965

(51) Int. Cl. B60W 20/13; B60L 1/00; B60W 10/06; B60W 10/26; B60K 6/40

(52) U.S. Cl. CPC B60W 20/13; B60L 1/006; B60W 10/06; B60W 10/26; B60K 6/40; B60W 2510/244; B60W 2510/305; B60W 2710/06; B60W 2710/244; B60Y 2200/92; B60Y 2300/91

(57) ABSTRACT

A hybrid electric vehicle according to one aspect of the present disclosure includes an internal combustion engine, a generator, a battery, an external power supply connector, and a control device. The control device starts charging of the battery by driving the internal combustion engine to cause the generator to generate the electricity, in accordance with the remaining amount of energy of the battery having reached a lower limit amount. The control device ends the charging of the battery by stopping the driving of the internal combustion engine, in accordance with the remaining amount of the energy of the battery having reached an upper limit amount that is set. The control device is configured to modify the upper limit amount by determining the value of the upper limit amount and setting the upper limit amount to the value that is determined.

### CROSS-REFERENCE TO RELATED APPLICATION

This application claims priority to Japanese Patent Application No. 2025-034965 filed on Mar. 5, 2025. The disclosure of the above-identified application, including the specification, drawings, and claims, is incorporated by reference herein in its entirety.

### BACKGROUND

### 1. Technical Field

The present disclosure relates to a hybrid electric vehicle.

### 2. Description of Related Art

Japanese Unexamined Patent Application Publication No. 2019-162896 (JP 2019-162896 A) proposes a hybrid electric vehicle configured such that, when the remaining amount of energy of a battery is equal to or greater than a predetermined amount, electric power of a battery can be supplied to an external device.

### SUMMARY

An object of the present disclosure is to provide a technique for charging a battery during external power supply, in which it is possible to switch between prioritizing quietness and prioritizing power supply efficiency.

A hybrid electric vehicle according to a first aspect of the present disclosure includes an internal combustion engine, a generator, a battery, an external power supply connector, and a control device. The generator is configured to generate electricity using power from the internal combustion engine. The battery is connected to the generator via an electric power line. The external power supply connector is configured to supply the electric power of the battery to an external device to be connected. The control device is configured to execute the following processing:

monitoring a remaining amount of energy of the battery while the electric power of the battery is being supplied to the external device via the external power supply connector;

starting charging of the battery by driving the internal combustion engine to cause the generator to generate the electricity, in accordance with a result of the monitoring indicating that the remaining amount of the energy of the battery has reached a lower limit amount;

monitoring the remaining amount of the energy of the battery while the charging continues after the charging of the battery is started; and

ending the charging of the battery by stopping the driving of the internal combustion engine, in accordance with a result of the monitoring indicating that the remaining amount of the energy of the battery has reached an upper limit amount that is set.

The control device is configured to further execute:

determining a value of the upper limit amount; and

setting the upper limit amount to the value that is determined.

According to the present disclosure, it is possible to execute the external power supply by switching between prioritizing quietness and prioritizing power supply efficiency.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 schematically illustrates an example configuration of a hybrid electric vehicle;

FIG. 2 schematically illustrates an example of the relationship between the operation of the internal combustion engine and the remaining amount of energy of a battery at each upper limit amount;

FIG. 3 schematically illustrates an example of a method of specifying the value of the upper limit amount;

FIG. 4 schematically illustrates an example of a method of determining the value of the upper limit amount;

FIG. 5 is a flowchart illustrating an example of a processing procedure related to the setting of the upper limit amount by the control device; and

FIG. 6 is a flowchart illustrating an example of a processing procedure related to the external power supply by the control device.

### DETAILED DESCRIPTION OF EMBODIMENTS

In recent years, a hybrid electric vehicle including an internal combustion engine (an engine or the like) and a battery has been commercially available. The hybrid electric vehicle is configured to supply the electric power of the battery to an external device. Supplying the electric power of the battery to the external device is also referred to as "external power supply". When the remaining amount of energy of the battery decreases, the hybrid electric vehicle may no longer secure a sufficient driving range. Therefore, the hybrid electric vehicle is configured such that, when the remaining amount of energy of the battery reaches a lower limit amount, the internal combustion engine is driven to allow the external power supply to be executed while charging the battery. The charging by driving the internal combustion engine is stopped when the remaining amount of energy of the battery reaches a predetermined amount (upper limit amount). In this case, when the upper limit amount used as a criterion for stopping the internal combustion engine is low, the driving time of the internal combustion engine (that is, the period during which the engine noise occurs) can be shortened, so that the quietness can be secured. However, the internal combustion engine may consume additional fuel when being driven. When the upper limit amount is low, the frequency of repeating the driving and the stopping of the internal combustion engine increases, so that the power supply efficiency may deteriorate. On the other hand, when the upper limit amount is high, the power supply efficiency can be improved, but the driving time of the internal combustion engine becomes longer, thereby deteriorating quietness.

In contrast, the hybrid electric vehicle according to the first aspect of the present disclosure includes an internal combustion engine, a generator, a battery, an external power supply connector, and a control device. The generator is configured to generate electricity using power from the internal combustion engine. The battery is connected to the generator via an electric power line. The external power supply connector is configured to supply the electric power of the battery to an external device to be connected. The control device is configured to execute the following processing:

monitoring a remaining amount of energy of the battery while the electric power of the battery is being supplied to the external device via the external power supply connector;

starting charging of the battery by driving the internal combustion engine to cause the generator to generate the electricity, in accordance with a result of the monitoring indicating that the remaining amount of the energy of the battery has reached a lower limit amount;

monitoring the remaining amount of the energy of the battery while the charging continues after the charging of the battery is started; and

ending the charging of the battery by stopping the driving of the internal combustion engine, in accordance with a result of the monitoring indicating that the remaining amount of the energy of the battery has reached an upper limit amount that is set.

The control device is configured to further execute: determining a value of the upper limit amount; and setting the upper limit amount to the value that is determined.

In the first aspect of the present disclosure, the value of the upper limit amount can be modified by a process of setting the value of the upper limit amount (determining the value of the upper limit amount and setting the upper limit amount using the value that is determined). By setting the value of the upper limit amount to be high, the frequency of repeating the driving and the stopping of the internal combustion engine can be suppressed, and as a result, the improvement of the power supply efficiency can be achieved. On the other hand, by setting the value of the upper limit amount to be low, the driving time of the internal combustion engine can be suppressed, and as a result, the quietness can be secured. Therefore, according to the first aspect of the present disclosure, by modifying (adjusting) the value of the upper limit amount, it is possible to charge the battery during the external power supply by switching between prioritizing quietness and prioritizing power supply efficiency.

As another embodiment of the hybrid electric vehicle according to the above aspect, one aspect of the present disclosure may be a control device mounted on the hybrid electric vehicle. Further, one aspect of the present disclosure may be an information processing method executed by the control device, a program, or a storage medium readable by a machine, such as a computer, that stores such a program. Here, the storage medium readable by a machine refers to a medium that stores information such as a program by electrical, magnetic, optical, mechanical, or chemical means.

### Configuration Example

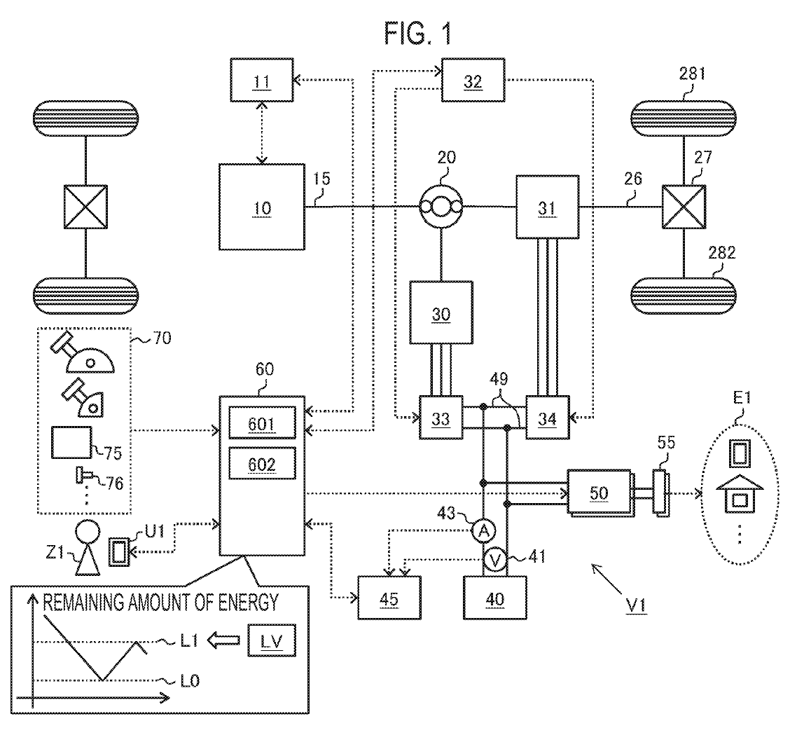

FIG. 1 schematically illustrates an example of a configuration of the hybrid electric vehicle V1 according to the present embodiment. The hybrid electric vehicle V1 according to the present embodiment includes an engine 10, a motor 30, a battery 40, an external power supply connector 55, and a control device 60.

### Engine Peripherals

The engine 10 is an example of an internal combustion engine. The type of the engine 10 (internal combustion engine) may not be particularly limited and may be selected as appropriate according to the embodiment. In one example, the engine 10 may be configured as an internal combustion engine that outputs power as a fuel such as gasoline, diesel, or hydrogen. In one example, the hybrid electric vehicle V1 may further include a control unit 11 for the engine 10, and the operation of the engine 10 may be controlled by the control unit 11.

The configuration of the control unit 11 may be optionally determined. In one example, the control unit 11 may include an ECU (Electronic Control Unit) including a processor, a memory, an input/output port, a communication port, and the like. The control unit 11 may receive an input of various types of information (a signal of a sensor or the like) used for controlling the engine 10 via an input port. The various types of information may include, for example, a crank angle of a crankshaft 15 of the engine 10, a throttle opening degree in a throttle valve, a temperature of the coolant of the engine 10, and a remaining amount of fuel in a fuel tank. The crank angle may be measured by a crank position sensor that detects a rotational position of the crankshaft 15. The throttle opening degree may be measured by a throttle valve position sensor that detects a position of the throttle valve. The temperature of the coolant may be measured by a water temperature sensor. The remaining amount of the fuel may be measured by a fuel sensor provided in the fuel tank. The control unit 11 may output a control signal for controlling the operation of the engine 10 via an output port. The output control signal may include, for example, a control signal to a throttle motor that adjusts the position of the throttle valve, a control signal to a fuel injection valve, and a control signal to an ignition coil. In addition, the control unit 11 may be connected to the control device 60 via a network through a communication port. The type of the network may be optionally selected. The network may be, for example, a controller area network (CAN). The control unit 11 may be configured to control the operation of the engine 10 in accordance with the control signal from the control device 60. The control unit 11 may be configured to output data related to the operating state of the engine 10 to the control device 60. In one example, the control unit 11 may calculate the rotational speed of the crankshaft 15, that is, the rotational speed of the engine 10 based on the crank angle measured by the crank position sensor. As a result, the control unit 11 may control the operation of the engine 10 while monitoring the rotational speed of the engine 10 as a control amount.

### Motor Peripherals

In one example, the hybrid electric vehicle V1 may further include a planetary gear 20 and a motor 31. The planetary gear 20 may be configured as a single-pinion type planetary gear mechanism. A sun gear of the planetary gear 20 may be connected to a rotor of the motor 30. A drive shaft 26 may be connected to a ring gear of the planetary gear 20. A pair of drive wheels (281, 282) may be connected to the drive shaft 26 via a differential device 27. The crankshaft 15 of the engine 10 may be connected to a carrier of the planetary gear 20. As a result, the hybrid electric vehicle V1 may be configured to obtain a drive force by outputting the power of the engine 10 to the drive wheels (281, 282).

In one example, the motor 30 may be configured as a synchronous generator motor. The motor 30 is an example of a generator. The configuration of the generator may be optionally modified. In one example of the present embodiment, the power of the engine 10 can be transmitted to the motor 30 via the planetary gear 20. The motor 30 is configured to generate electricity using the power transmitted from the engine 10. The motor 31 may be configured as a synchronous generator motor. The rotor of the motor 31 may be connected to the drive shaft 26. The hybrid electric vehicle V1 may further include inverters (33, 34) corresponding to the respective motors (30, 31). Each of the inverters (33, 34) may be connected to an electric power line 49 together with the battery 40. In one example, the hybrid electric vehicle V1 may further include a control unit 32 for each of the motors (30, 31). The switching device of each of the inverters (33, 34) may be switching-controlled by the control unit 32, so that each of the motors (30, 31) may be rotationally driven.

The configuration of the control unit 32 may be optionally determined. In one example, the control unit 32 may include an ECU including a processor, a memory, an input/output port, a communication port, and the like, as in the control unit 11. The control unit 32 may receive an input of various types of information (a signal of a sensor or the like) used for controlling each of the motors (30, 31) via an input port. The various types of information may include, for example, a rotational position of each of the motors (30, 31) and a phase current of each of the motors (30, 31). The rotational position (rotational speed) may be measured by an encoder (a sensor that detects the rotational position of the rotor) provided in each of the motors (30, 31). The phase current may be derived from a measurement value of a current sensor that measures a current flowing in each phase of each of the motors (30, 31). The control unit 32 may output a control signal for controlling the operation of each of the motors (30, 31) via an output port. The control signal to be output may include, for example, a switching control signal to a switching element of each of the inverters (33, 34). In addition, the control unit 32 may be connected to the control device 60 via a network through a communication port, as in the control unit 11. The control unit 32 may be configured to control the operation of each of the motors (30, 31) in accordance with the control signal from the control device 60. The control unit 32 may be configured to output data related to the operating state of each of the motors (30, 31) to the control device 60. In one example, the control unit 32 may calculate the rotational speed of each of the motors (30, 31) based on the rotational position of the rotor of each of the motors (30, 31), the rotational position being measured by each encoder. As a result, the control unit 32 may control the operation of each of the motors (30, 31) while monitoring the rotational speed of each of the motors (30, 31) as a control amount.

### Battery Peripherals

The type of the battery 40 may not be particularly limited and may be selected as appropriate according to the embodiment. In one example, the battery 40 may include a secondary battery such as a lithium-ion secondary battery or a nickel-metal hydride secondary battery. The battery 40 may be connected to the electric power line 49 together with each of the inverters (33, 34). As a result, the battery 40 may be connected to the motor 30 (generator) via the electric power line 49. With the battery 40 connected to the motor 30, the hybrid electric vehicle V1 may be configured to charge the battery 40 with electric power generated by the motor 30 as driven by the engine 10. In addition, the battery 40 may be connected to the motor 31 via the electric power line 49. With the battery 40 connected to the motor 31, the hybrid electric vehicle V1 may be configured to obtain a drive force by driving the motor 31 with the electric power of the battery 40. In one example, the hybrid electric vehicle V1 may further include a control unit 45 for the battery 40, and the state of the battery 40 may be managed by the control unit 45.

The configuration of the control unit 45 may be optionally determined. In one example, the control unit 45 may include an ECU including a processor, a memory, an input/output port, a communication port, and the like, as in the control unit 11 and the like. The control unit 45 may receive an input of various types of information (a signal of a sensor or the like) used for managing the battery 40 via an input port. The various types of information may include, for example, a voltage of the battery 40, a current at an output terminal of the battery 40, and a temperature of the battery 40. The voltage of the battery 40 may be measured by a voltage sensor 41 installed between terminals of the battery 40. The current at the output terminal may be measured by a current sensor 43 installed at the output terminal of the battery 40. The temperature of the battery 40 may be measured by a temperature sensor attached to the battery 40. In addition, the control unit 45 may be connected to the control device 60 via a network through a communication port, as in the control unit 11 and the like. The control unit 45 may be configured to output data related to the state of the battery 40 to the control device 60. In one example, the control unit 45 may calculate the remaining amount of energy based on an integrated value of the current measured by the current sensor 43. The remaining amount of energy may be a capacity of the electric power that can be discharged from the battery 40 with respect to a total capacity of the battery 40. The remaining amount of energy may be calculated as a state of charge (SOC). The method of calculating the remaining amount of energy may not be limited to such an example and may be modified as appropriate according to the embodiment. In addition, the control unit 45 may calculate the input/output limit based on the calculated remaining amount of energy and the temperature measured by the temperature sensor. The input limit is a maximum allowable electric power when the battery 40 is charged, and the output limit is a maximum allowable electric power when the battery 40 is discharged. The value of the input/output limit may be optionally determined by any method. For example, the input/output limit of the battery 40 may be calculated by (A) setting a basic value of the input/output limit based on the temperature of the battery 40, (B) setting a correction coefficient based on the remaining amount of energy of the battery 40, and (C) integrating the correction coefficient with the basic value. In one example, the output limit of the battery 40 may be set to be smaller as the temperature of the battery 40 deviates from the allowable temperature range toward a higher side or a lower side, and to be lower as the remaining amount of energy of the battery 40 is smaller. The input limit of the battery 40 may be set to be larger (smaller in absolute value) as the temperature of the battery 40 deviates from the allowable temperature range toward a higher side or a lower side, and to be larger (smaller in absolute value) as the remaining amount of energy of the battery 40 is higher.

### External Power Supply Connector

The external power supply connector 55 may be connected to the electric power line 49 via the charge/discharge device 50. The external device E1 may be connected to the external power supply connector 55. As a result, the external power supply connector 55 according to the present embodiment is configured to supply the electric power on the electric power line 49 (at least one of the electric power of the battery 40 and the electric power generated by the motor 30 as driven by the engine 10) to the connected external device E1. The type of the external power supply connector 55 and the method of connecting to the external device E1 may not be particularly limited and may be selected as appropriate according to the embodiment. In one example, the external power supply connector 55 may include a socket that directly accepts a connection of a plug of the external device E1. In another example, the external power supply connector 55 may be configured to accept a connection of a dedicated attachment such as a vehicle power connector and to be indirectly connected to the external device E1 via the attachment. The electric power output from the external power supply connector 55 may be either direct current or alternating current. In one example, the charge/discharge device 50 may be configured to convert the direct current electric power on the electric power line 49 into alternating current electric power by including an inverter and to supply the obtained alternating current electric power to the external device E1 connected to the external power supply connector 55. The charge/discharge device 50 may be replaced with an inverter. The charge/discharge device 50 may be configured to supply the direct current electric power on the electric power line 49 to the external device E1. The operation of the charge/discharge device 50 may be controlled by the control device 60. Supplying the electric power on the electric power line 49 to the external device E1 may be referred to as "external power supply".

In addition, the number of the external power supply connectors 55 may be optionally determined. In one example, the hybrid electric vehicle V1 may include a plurality of external power supply connectors 55. Each of the external power supply connectors 55 may be connected to the electric power line 49 via the charge/discharge device 50. When the hybrid electric vehicle V1 includes the external power supply connectors 55, the type of each of the external power supply connectors 55 and the method of connecting to the external device E1 may be the same or may differ at least partially.

The type of the external device E1 may not be particularly limited and may be selected as appropriate according to the embodiment. The external device E1 may include, for example, an electric product such as a mobile terminal or a notebook personal computer (PC). The mobile terminal may include a smartphone, a tablet terminal, and the like. The external device E1 may include facilities such as a house. The external power supply connector 55 may be configured to be connectable to a charging facility. Alternatively, the hybrid electric vehicle V1 may further include another connector connected to the electric power line via the charge/discharge device, and the other connector may be configured to be connected to the charging facility. As a result, the hybrid electric vehicle V1 may be configured to charge the battery 40 with the electric power from the connected charging facility.

### Control Device

The configuration of the control device 60 may be optionally determined. In one example, the control device 60 may include an ECU including a processor 601, a memory 602, an input/output port, a communication port, and the like, as in the control unit 11 and the like. The type of the processor 601 may be optionally selected. For example, the processor 601 may include a central processing unit (CPU), a microprocessor, a field-programmable gate array (FPGA), or an application specific integrated circuit (ASIC). The type of the memory 602 may be optionally selected. For example, the memory 602 may include RAM, ROM, or a semiconductor memory. The memory 602 may store various types of information such as a control program. The control program may include various commands for controlling the operation of the hybrid electric vehicle V1.

The control device 60 may receive an input of various types of information (a signal of a sensor, data from another control unit, or the like) used for controlling the hybrid electric vehicle V1 via the input port. The various types of information may include a signal of an operation device 70, operation information of the operation device 70, or the like. The operation information of the operation device 70 may be obtained by a sensor. For example, the operation device 70 may include an ignition switch, and the various types of information may include an ignition signal. The operation device 70 may include a shift lever, and the various types of information may include an operation position (shift position) of the shift lever. The operation position of the shift lever may be measured by a shift position sensor. The operation device 70 may include an accelerator pedal, and the various types of information may include a depression amount (accelerator operation amount) of the accelerator pedal. The accelerator operation amount may be measured by an accelerator pedal position sensor. The operation device 70 may include a brake pedal, and the various types of information may include a depression amount (brake pedal position) of the brake pedal. The brake pedal position may be measured by a brake pedal position sensor. In addition, the various types of information may include the electric power supplied during the external power supply from the external power supply connector 55, a vehicle speed of the hybrid electric vehicle V1, or the like. The supplied electric power may be measured by an electric power sensor. The vehicle speed of the hybrid electric vehicle V1 may be measured by a vehicle speed sensor. The control device 60 may output a control signal to the charge/discharge device 50 via the output port. The control device 60 may be connected to each of the control units (11, 32, 45) through the communication port. As a result, the control device 60 may receive various types of data from each of the control units (11, 32, 45). The control device 60 may output a control signal to each of the control units (11, 32, 45).

In addition, the operation device 70 may include an input device. That is, the control device 60 may be connected to the input device. The various types of information may include an operation (input) of the input device. The type of the input device may be optionally selected. The input device may include, for example, a touch panel 75, an operator 76, or a microphone. In addition, the control device 60 may be connected to an output device. The type of the output device may be optionally selected. The output device may include, for example, a display, or a speaker. The control device 60 may output any information to the output device. The control device 60 may be connected to the input device and the output device by any method. In one example, the control device 60 may be directly connected to the input device and the output device via the input/output port. In another example, the control device 60 may be indirectly connected to the input device and the output device through a communication port via a device such as a control unit (ECU or the like).

The control device 60 may control the operation of the hybrid electric vehicle V1 as appropriate. In one example, when the hybrid electric vehicle V1 is being driven and the operation position of the shift lever is a drive position (D position) or a reverse position (R position), the control device 60 may set a drive force to be requested to the drive shaft 26 based on the accelerator operation amount and the vehicle speed. Then, the control device 60 may control the operation of the engine 10 and each of the motors (30, 31) such that the power corresponding to the set drive force is output to the drive shaft 26. The power output to the drive shaft 26 may be obtained from at least one of the engine 10 and the battery 40. A known method such as JP 2019-162896 A may be adopted for the operation control during the driving.

### Control Device / Execution of External Power Supply

In addition, the control device 60 may be configured to execute the external power supply from the battery 40 to the external device E1 in response to the establishment of a predetermined operating condition. The operating conditions may be optionally set. In one example, the operating conditions may be that the external device E1 is connected to the external power supply connector 55, the operating position of the shift lever is a parking position (P position), and an instruction to execute the external power supply has been provided. The instruction to execute the external power supply may be optionally provided. For example, the instruction to execute the external power supply may be provided in response to the switching on of a switch for the external power supply in the input device by the user. The switch for the external power supply may be either a software switch (the touch panel 75 or the like) and a physical switch (the operator 76 or the like).

### Control Device / Charging of Battery

In the present embodiment, the control device 60 may be configured to execute the following processing.

(1) monitoring a remaining amount of energy of the battery 40 while the electric power of the battery 40 is being supplied to the external device E1 via the external power supply connector 55;

(2) starting charging of the battery 40 by driving the engine 10 to cause the motor 30 to generate the electricity, in accordance with a result of the monitoring indicating that the remaining amount of the energy of the battery 40 has reached a lower limit amount L0;

(3) monitoring the remaining amount of the energy of the battery 40 while the charging continues after the charging of the battery 40 by driving the engine 10 is started; and

(4) ending the charging of the battery 40 by stopping the driving of the engine 10, in accordance with a result of the monitoring indicating that the remaining amount of the energy of the battery 40 has reached an upper limit amount L1 that is set.

The method of monitoring the remaining amount of energy in (1) and (3) above may not be particularly limited and may be selected as appropriate according to the embodiment. In one example, the control unit 45 may calculate the remaining amount of energy of the battery 40 and transmit data indicating the calculated remaining amount of energy (calculation result) to the control device 60. The control device 60 may monitor the remaining amount of energy of the battery 40 by receiving the data. A timing at which the remaining amount of energy is monitored may be optionally determined. The control unit 45 may repeatedly execute the calculation of the remaining amount of energy of the battery 40 and the transmission of the calculation result to the control device 60. As a result, the control device 60 may continuously monitor the remaining amount of energy of the battery 40 via the control unit 45.

In the monitoring processing of (1), the control device 60 may determine whether the remaining amount of energy of the battery 40 has reached the lower limit amount L0 in accordance with the result of the monitoring of the remaining amount of energy. When the remaining amount of energy acquired as the result of the monitoring exceeds the lower limit amount L0, the control device 60 may determine that the remaining amount of energy has not reached the lower limit amount L0. On the other hand, when the acquired remaining amount of energy is less than the lower limit amount L0, the control device 60 may determine that the remaining amount of energy has reached the lower limit amount L0. When the acquired remaining amount of energy is equal to the lower limit amount L0, the control device 60 may determine that the remaining amount of energy has reached the lower limit amount L0 or may determine that the remaining amount of energy has not reached the lower limit amount L0.

In (2), the control device 60 provides the control signal to each of the control units (11, 32) in response to the determination that the remaining amount of energy of the battery 40 has reached the lower limit amount L0. By the control signal, the charging of the battery 40 by driving the engine 10 may be started. A part of the electric power generated by the motor 30 as driven by the engine 10 may be supplied to the external device E1 or may not be supplied to the external device E1. In addition, the external power supply mode in which the electric power of the battery 40 is automatically replenished by driving the engine 10 may be referred to as an HV power supply mode. In addition, the hybrid electric vehicle V1 may be configured to execute an operation of an EV power supply mode in which the engine 10 is not driven and solely the electric power of the battery 40 is used for the external power supply.

In the monitoring processing of (3), the control device 60 may determine whether the remaining amount of energy of the battery 40 has reached the upper limit amount L1 in accordance with the result of the monitoring of the remaining amount of energy. When the remaining amount of energy acquired as the result of the monitoring is less than the upper limit amount L1, the control device 60 may determine that the remaining amount of energy has not reached the upper limit amount L1. On the other hand, when the acquired remaining amount of energy exceeds the upper limit amount L1, the control device 60 may determine that the remaining amount of energy has reached the upper limit amount L1. When the acquired remaining amount of energy is equal to the upper limit amount L1, the control device 60 may determine that the remaining amount of energy has reached the upper limit amount L1 or may determine that the remaining amount of energy has not reached the upper limit amount L1.

In (4), the control device 60 provides the control signal to each of the control units (11, 32) in response to the determination that the remaining amount of energy of the battery 40 has reached the upper limit amount L1. By the control signal, the charging of the battery 40 by driving the engine 10 may be ended. The control device 60 may continuously execute the operations of (1) to (4) while executing the external power supply.

### Control Device / Upper Limit Amount

The upper limit amount L1 is a threshold value that serves as a criterion for ending the charging of the battery 40 by driving the engine 10 during the external power supply. The upper limit amount L1 (upper limit threshold value) may be optionally defined. In the present embodiment, the control device 60 is configured to further execute: determining the value LV of the upper limit amount L1; and setting the upper limit amount L1 to the value LV that is determined. As a result, the control device 60 can modify the value LV of the upper limit amount L1. By setting the value LV of the upper limit amount L1 to be high, the frequency of repeating the driving and the stopping of the engine 10 can be suppressed. On the other hand, by setting the value LV of the upper limit amount L1 to be low, the driving time of the engine 10 can be suppressed.

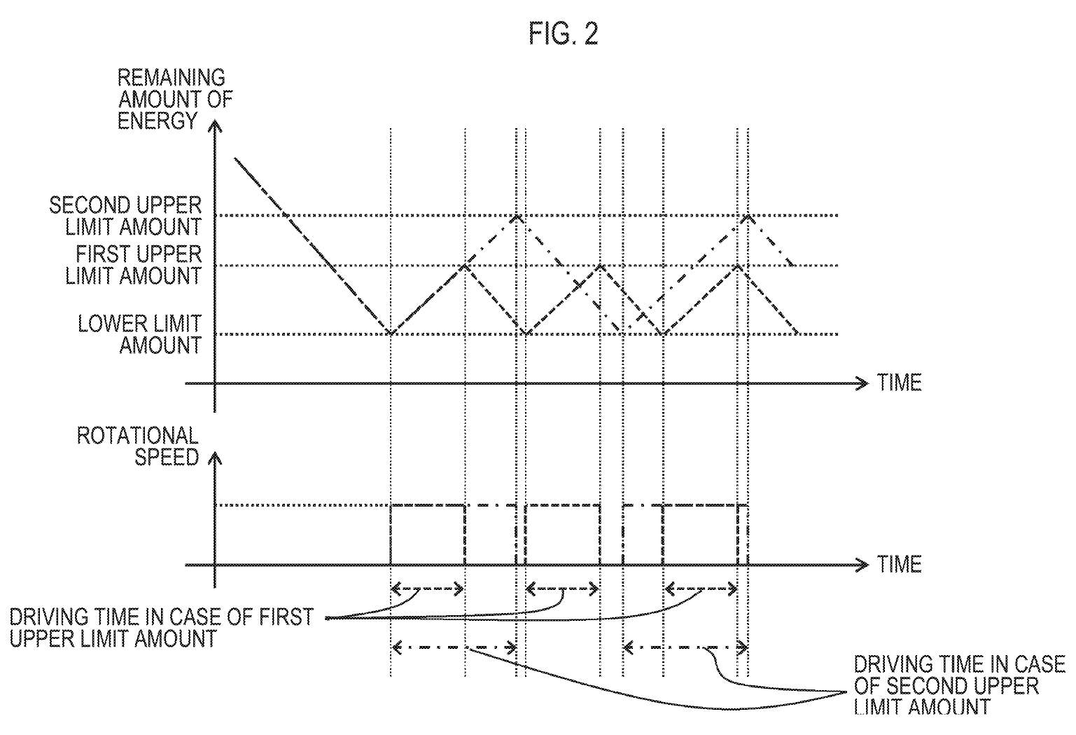

FIG. 2 schematically illustrates an example of a relationship between the driving (rotational speed) of the engine 10 and the remaining amount of energy of the battery 40 at each of two upper limit amounts (first upper limit amount and second upper limit amount) when the two upper limit amounts are provided. In the example of FIG. 2, a situation is assumed in which the driving conditions (lower limit amount, rotational speed, and the like) of the engine 10 other than the upper limit amount are the same, the external power supply is continuously executed, and the discharge (external power supply) of the battery 40 during the period in which the engine 10 is not driven is constant. The second upper limit amount is set to a value higher than the first upper limit amount, and a situation is assumed in which the amount of charging by driving the engine 10 is constant regardless of the remaining amount of energy of the battery 40. In this scene, when the second upper limit amount is adopted, the driving time of the engine 10 per charging is longer as compared with a case where the first upper limit amount is adopted. As a result, the amount of charging of the battery 40 can be increased, so that the frequency of repeating the driving and the stopping of the engine 10 can be suppressed. Therefore, by adopting the second upper limit amount, the improvement of the power supply efficiency can be expected as compared with a case where the first upper limit amount is adopted. The good power supply efficiency may be that the amount of charging of the battery (battery 40) is large when the internal combustion engine (engine 10) is driven by consuming a predetermined amount of fuel. The power supply efficiency may be referred to as "fuel efficiency". On the other hand, when the first upper limit amount is adopted, the driving time of the engine 10 per charging is shorter as compared with a case where the second upper limit amount is adopted. As a result, the time during which the driving noise of the engine 10 is generated can be suppressed. Therefore, by adopting the first upper limit amount, the quietness can be expected to be secured as compared with a case where the second upper limit amount is adopted. The driving conditions of the engine 10 may also exist other than the upper limit amount L1 when the battery 40 is charged. The driving conditions other than the upper limit amount L1 may include, for example, a value of the lower limit amount L0, a driving amount of the engine 10, a torque, and a rotational speed. Among cases in which different values are adopted for the upper limit amount L1, the driving conditions other than the upper limit amount L1 may be the same or may differ at least partially.

### Control device / Method of Specifying Upper Limit Amount

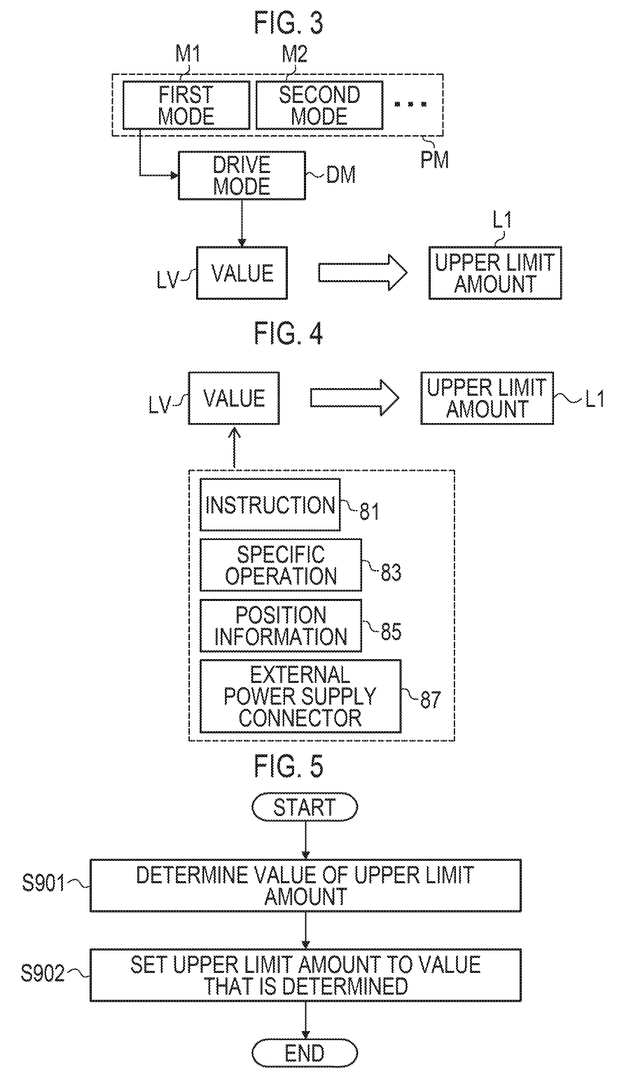

A method of specifying the value LV of the upper limit amount L1 may not be particularly limited and may be selected as appropriate according to the embodiment. The value LV of the upper limit amount L1 may be specified by a continuous value or may be specified by a discrete value. A known user interface such as a slider (seek bar), a stepper, a checkbox, a radio button, a toggle switch, and a choice chip may be used to specify the value LV of the upper limit amount L1. The value LV of the upper limit amount L1 may be directly specified or may be indirectly specified as in the mode selection in FIG. 3.

FIG. 3 schematically illustrates an example of a method of specifying the value LV of the upper limit amount L1. In one example, determining the value LV of the upper limit amount L1 may include selecting one mode from among a plurality of modes PM. Each of the modes PM may define the value LV of the upper limit amount L1. In one example, each of the modes PM may define the driving conditions of the engine 10 when the battery 40 is charged. The driving conditions defined in each of the modes PM may include or may not include other conditions other than the value LV of the upper limit amount L1 as long as the value LV of the upper limit amount L1 is included. The other conditions other than the value LV of the upper limit amount L1 may include, for example, a value of the lower limit amount L0, a driving amount of the engine 10, a torque, and a rotational speed. Among the modes PM, conditions other than the value LV of the upper limit amount L1 may be the same or may differ at least partially. The mode that is selected may be referred to as a drive mode DM. Setting the upper limit amount L1 to the value LV that is determined may include setting the upper limit amount L1 to the value LV defined in the mode that is selected (drive mode DM). The control device 60 may determine the control command to be provided to each of the control units (11, 32) in accordance with the driving conditions defined in the mode that is selected (driving mode DM). The modes PM may include a first mode M1 and a second mode M2. The second mode M2 may be defined such that the value LV of the upper limit amount L1 is higher than the value LV of the upper limit amount L1 in the first mode M1. According to one example of the present embodiment, the value LV of the upper limit amount L1 can be specified via the mode selection. As a result, the simplification of the processing of specifying the value LV of the upper limit amount L1 can be expected.

In the second mode M2, the value LV of the upper limit amount L1 is defined to be higher than the value LV of the upper limit amount L1 in the first mode M1, so that the quietness may deteriorate, but the improvement of the power supply efficiency can be expected. On the other hand, in the first mode M1, the power supply efficiency may deteriorate, but the quietness can be expected to be secured. In an example of FIG. 3, by switching the drive mode DM between the first mode M1 and the second mode M2, it is possible to execute charging of the battery 40 during the external power supply by switching between prioritizing quietness and prioritizing power supply efficiency. The first mode M1 may be referred to as a quietness-priority mode, and the second mode M2 may be referred to as a power supply efficiency-priority mode. A difference between the values LV of the upper limit amount L1 between the first mode M1 and the second mode M2 may not be particularly limited and may be defined as appropriate according to the embodiment. In one example, the other conditions other than the value LV of the upper limit amount L1 may be the same between the first mode M1 and the second mode M2. However, the relationship between the first mode M1 and the second mode M2 may not be limited to such an example. As long as the first mode M1 prioritizes quietness and the second mode M2 prioritizes power supply efficiency, at least a part of the other conditions other than the value LV of the upper limit amount L1 may differ between the first mode M1 and the second mode M2. The modes PM may solely include the first mode M1 and the second mode M2, or may further include one or more other modes in addition to the first mode M1 and the second mode M2. Any of the one or more other modes may be selected as the drive mode DM. As long as the two modes corresponding to the first mode M1 and the second mode M2 are included, in part of the modes PM, the value LV of the upper limit amount L1 that is defined may be the same.

### Control Method / Method of Determining Upper Limit Amount

A method of determining the value LV of the upper limit amount L1 may not be particularly limited and may be selected as appropriate according to the embodiment. In one example of the present embodiment, the control device 60 may be configured to determine the value LV of the upper limit amount L1 by at least one of the following four methods. When the embodiment in which the value LV of the upper limit amount L1 is determined by selecting the mode is adopted, a method of selecting one mode from among the modes PM may not be particularly limited and may be selected as appropriate according to the embodiment. The method of selecting the mode corresponds to the method of determining the value LV of the upper limit amount L1. In one example of the present embodiment, the control device 60 may be configured to select one mode from among the modes PM by at least one of the following four methods.

FIG. 4 schematically illustrates an example of a method of determining the value LV of the upper limit amount L1. In the first method, determining the value LV of the upper limit amount L1 may include receiving an instruction 81 from a user Z1 and determining the value LV of the upper limit amount L1 in response to the instruction 81 from the user Z1. That is, a value corresponding to the instruction 81 from the user Z1 may be adopted as the value LV of the upper limit amount L1. In one example, the instruction 81 from the user Z1 may directly indicate the value LV of the upper limit amount L1. In another example, the instruction 81 from the user Z1 may indirectly indicate the value LV of the upper limit amount L1 via a change amount (increase amount, decrease amount, or the like) from a set value (the value LV of the upper limit amount L1 immediately before the instruction 81 is provided, a reference value, or the like). The instruction 81 from the user Z1 may be received by any method. In the example, the control device 60 may receive the instruction 81 from the user Z1 via the input device (the touch panel 75, the operator 76, or the like). In another example, the control device 60 may be configured to receive data of a remote operation from the user terminal U1. The control device 60 may be directly or indirectly connected to the user terminal U1. The control device 60 may be connected to the user terminal U1 via an input port or a communication port. The control device 60 may be connected to the user terminal U1 via another control unit, any network, or the like. The control device 60 may receive the instruction 81 from the user Z1 via the remote operation from the user terminal U1.

In one example, in the first method, the specifying method of FIG. 3 may be further adopted. That is, in one example, selecting one mode may include receiving the instruction 81 from the user Z1 and selecting one mode from among the modes PM in response to the instruction 81 from the user Z1. The mode corresponding to the instruction 81 from the user Z1 may be selected as the drive mode DM.

In the second method, determining the value LV of the upper limit amount L1 may include receiving a specific operation 83 via the operation device 70 provided in the hybrid electric vehicle V1 and determining the value LV of the upper limit amount L1 in response to the specific operation 83. That is, a value corresponding to the executed specific operation 83 may be adopted as the value LV of the upper limit amount L1. In one example, the specific operation 83 may directly instruct the value LV of the upper limit amount L1. In another example, the specific operation 83 may indirectly instruct the value LV of the upper limit amount L1 via a change amount (increase amount, decrease amount, or the like) from a set value (the value LV of the upper limit amount L1 immediately before the specific operation 83 is provided, a reference value, or the like). The specific operation 83 may be any operation different from the normal operation of the vehicle (hybrid electric vehicle V1). In one example, the specific operation 83 may include an operation that is not normally executed when the hybrid electric vehicle V1 is powered on, such as setting the operation position of the shift lever to the P position and setting the accelerator operation amount to 100%. When the specific operation 83 is executed while the hybrid electric vehicle V1 is powered on, the control device 60 may set the value corresponding to the specific operation 83 as the value LV of the upper limit amount L1. After being powered on, the control device 60 may operate the external power supply at the upper limit amount L1 that is set. A correspondence relationship between the value LV of the upper limit amount L1 and the specific operation 83 may not be particularly limited and may be defined as appropriate according to the embodiment. The correspondence relationship between the value LV of the upper limit amount L1 and the specific operation 83 may be defined as appropriate in a program or the like. The specific operation 83 is preferably an operation that can be executed at once. The specific operation 83 is easily executed. Therefore, according to one example of the present embodiment, the value LV of the upper limit amount L1 can be determined by the specific operation 83, so that the reduction of the effort when the value LV of the upper limit amount L1 is modified can be expected.

In one example, in the second method as well, the specifying method of FIG. 3 may be further adopted. That is, in one example, selecting one mode may include receiving the specific operation 83 via the operation device 70 provided in the hybrid electric vehicle V1 and selecting one mode from among the modes PM in response to the specific operation 83. The mode corresponding to the executed specific operation 83 may be selected as the drive mode DM. The specific operation 83 corresponding to each of the modes PM (first mode M1 and second mode M2) may not be particularly limited and may be defined as appropriate according to the embodiment. The correspondence relationship between each of the modes PM and the specific operation 83 may be defined as appropriate in a program or the like.

In the third method, determining the value LV of the upper limit amount L1 may include acquiring position information 85 of the hybrid electric vehicle V1 and determining the value LV of the upper limit amount L1 in accordance with the position information 85 that is acquired. The position information 85 may be acquired by any method. In one example, the hybrid electric vehicle V1 may include a positioning module. The positioning module may be deployed as appropriate in the hybrid electric vehicle V1. For example, the positioning module may be directly deployed in the hybrid electric vehicle V1. In addition, the positioning module may be deployed in equipment such as a navigation device mounted on the hybrid electric vehicle V1 (that is, may be indirectly deployed in the hybrid electric vehicle V1). The control device 60 may acquire the position information 85 measured by the positioning module through the input port or the communication port. In another example, the user terminal (the user terminal U1 or the like) may include a positioning module. The control device 60 may acquire the position information 85 measured by the positioning module of the user terminal by communicating with the user terminal. As in these examples, the position information 85 of the hybrid electric vehicle V1 may be directly measured by the positioning module deployed in the hybrid electric vehicle V1. The position information 85 of the hybrid electric vehicle V1 may be indirectly measured by a positioning module mounted on a device (user terminal or the like) other than the hybrid electric vehicle V1. The type of the positioning module may not be particularly limited and may be selected as appropriate according to the embodiment. For example, the positioning module may include a global positioning system (GPS) sensor, or a global navigation satellite system (GNSS) sensor. The position information 85 may be configured to indicate a current position of the hybrid electric vehicle V1.

A correspondence relationship between the value LV determined by the position information 85 may not be particularly limited and may be defined as appropriate according to the embodiment. The value LV of the upper limit amount L1 may be directly determined in accordance with the position information 85 or may be indirectly determined via a change amount (increase amount, decrease amount, or the like) from a set value (the value LV of the upper limit amount L1 immediately before being modified, a reference value, or the like). In one example, in a first region (residential area or the like) where the quietness is required, the value LV of the upper limit amount L1 may be determined to be a small value. On the other hand, in a second region (campground or the like) where the quietness is not required, the value LV of the upper limit amount L1 may be determined to be a large value as compared with the first region. The control device 60 may specify as appropriate a region to which the current position of the hybrid electric vehicle V1 indicated by the position information 85 belongs. For example, the control device 60 may specify the region to which the current position of the hybrid electric vehicle V1 indicated by the position information 85 that is acquired belongs by communicating with the navigation device or the user terminal. The region to which the current position belongs may be specified on the control device 60 or may be specified on the navigation device or the user terminal. When adopting the latter, acquiring the position information 85 may include acquiring a result of specifying the region to which the current position belongs.

Map information may be used as appropriate to specify the region to which the current position belongs. In one example, each region may be defined in advance in the map information. In this case, the region to which the current position belongs may be specified by comparing the current position with the definitions for each region on the map information. A method of defining each region may not be particularly limited and may be selected as appropriate according to the embodiment. For example, when a region on the map is divided into two regions of the first region and the second region, the second region may be defined as a region other than the first region by defining the first region. On the contrary, the first region may be defined as a region other than the second region by defining the second region. In another example, conditions for each region may be defined for the attributes of a position (road type, location, and the like) defined on map information. The region to which the current position belongs may be specified in accordance with which region's conditions are satisfied by the attribute value of the current position obtained from the map information. The map information may be stored in any storage region and may be referred to as appropriate when the region to which the current position belongs is specified. Any storage region may include, for example, a memory resource of the navigation device or the user terminal, or an external storage device (server device or the like). The control device 60 may determine the value LV of the upper limit amount L1 in accordance with the specified region. For example, the control device 60 may determine the value LV of the upper limit amount L1 to be a small value in accordance with the current position belonging to the first region (reducing from the set value, selecting a small value, or the like). The control device 60 may determine the value LV of the upper limit amount L1 to be a large value in accordance with the current position belonging to the second region (increasing from the set value, selecting a large value, or the like). According to one example of the present embodiment, it is possible to expect the execution of external power supply under conditions suitable for the location.

In one example, in the third method, the specifying method of FIG. 3 may be further adopted. That is, in one example, selecting one mode may include acquiring the position information 85 of the hybrid electric vehicle V1 and selecting one mode from the modes PM in accordance with the position information 85 that is acquired. A correspondence relationship between the position information and the selected mode may not be particularly limited and may be defined as appropriate according to the embodiment. In one example, the control device 60 may specify the region to which the current position indicated by the position information 85 belongs, and may select one mode from among the modes PM in accordance with the specified region. For example, the control device 60 may select a mode (first mode M1 or the like) that prioritizes the quietness in accordance with the current position belonging to the first region where the quietness is required. The control device 60 may select a mode (second mode M2 or the like) that prioritizes the power supply efficiency in accordance with the current position belonging to the second region where the quietness is not required.

In the fourth method, the hybrid electric vehicle V1 may include the external power supply connectors 55. Determining the value LV of the upper limit amount L1 may include determining the value LV of the upper limit amount L1 in accordance with an external power supply connector 87 that is used for connection with the external device E1 from among the external power supply connectors 55. A correspondence relationship between each of the external power supply connectors 55 and the determined value LV may be defined as appropriate according to the embodiment. The value LV of the upper limit amount L1 may be directly determined in accordance with the external power supply connector 87 to be used or may be indirectly determined via a change amount (increase amount, decrease amount, or the like) from a set value (the value LV of the upper limit amount L1 immediately before being modified, a reference value, or the like). In one example, the more an external power supply connector 55 that is likely to be connected to an external device E1 having high electric power consumption is used, the more likely the value LV of the upper limit amount L1 may be determined to be a higher value. The more an external power supply connector 55 that is likely to be connected to an external device E1 having low electric power consumption is used, the more likely the value LV of the upper limit amount L1 may be determined to be a smaller value. For example, the external power supply connectors 55 may include a first connector provided outside the hybrid electric vehicle V1 (outside the vehicle) and a second connector provided inside the hybrid electric vehicle V1 (inside the vehicle). Since the first connector is provided outside the vehicle, the first connector is likely to be connected to the external device E1 (facility or the like) having higher electric power consumption than the second connector. Therefore, when the first connector is used (that is, the first connector is the external power supply connector 87 to be used), the control device 60 may determine the value LV of the upper limit amount L1 to be a large value as compared with a case where the second connector is used (increasing from the set value, selecting a large value, or the like). On the other hand, when the second connector is used, the control device 60 may determine the value LV of the upper limit amount L1 to be a small value as compared with a case where the first connector is used (reducing from the set value, selecting a small value, or the like). According to one example of the present embodiment, the value LV of the upper limit amount L1 may be determined in accordance with the external power supply connector 87 to be used, so that the reduction of the effort when the upper limit amount L1 is set can be expected.

A method of determining the value LV of the upper limit amount L1 in accordance with the external device E1 may not be limited to such an example. In another example, when the hybrid electric vehicle V1 includes one external power supply connector 55, determining the value LV of the upper limit amount L1 may include determining the value LV of the upper limit amount L1 in accordance with at least one of the type of the external device E1 and the method of connecting to the external device E1. When the hybrid electric vehicle V1 includes the external power supply connectors 55, determining the value LV of the upper limit amount L1 may include determining the value LV of the upper limit amount L1 in accordance with at least one of the external power supply connector 87 to be used, the type of the external device E1, and the method of connecting to the external device E1. A correspondence relationship between each element and the determined value LV may be defined as appropriate according to the embodiment. In one example, as described above, the more likely the external device E1 having high electric power consumption is to be connected, the more likely the value LV of the upper limit amount L1 may be determined to be a higher value. The more likely the external device E1 having low electric power consumption is to be connected, the more likely the value LV of the upper limit amount L1 may be determined to be a smaller value.

In addition, in one example, in the fourth method, the specifying method of FIG. 3 may be further adopted. That is, in one example, selecting one mode may include selecting one mode from among the modes PM in accordance with the external power supply connector 87 that is used for connection with the external device E1 from among the external power supply connectors 55. A correspondence relationship between the external power supply connector 55 and the selected mode may be defined as appropriate according to the embodiment. When the hybrid electric vehicle V1 includes one external power supply connector 55, selecting one mode may include selecting one mode from among the modes PM in accordance with at least one of the type of the external device E1 and the method of connecting to the external device E1. When the hybrid electric vehicle V1 includes the external power supply connectors 55, selecting one mode may include selecting one mode from among the modes PM in accordance with at least one of the external power supply connector 87 to be used, the type of the external device E1, and the method of connecting to the external device E1. A correspondence relationship between each element and the selected mode may be defined as appropriate according to the embodiment. In one example, the more likely the external device E1 having high electric power consumption is to be connected, the more likely a mode (second mode M2 or the like) that prioritizes power supply efficiency may be selected. The more likely the external device E1 having low electric power consumption is to be connected, the more likely a mode (first mode M1 or the like) that prioritizes quietness may be selected. For example, when the first connector is used, the control device 60 may select a mode (second mode M2 or the like) that prioritizes the power supply efficiency from among the modes PM. On the other hand, when the second connector is used, the control device 60 may select a mode (first mode M1 or the like) that prioritizes the quietness from among the modes PM.

### Control device / Lower Limit Amount

The lower limit amount L0 is a threshold value that serves as a criterion for starting the charging of the battery 40 by driving the engine 10 during the external power supply. The lower limit amount L0 (lower limit threshold value) may be optionally defined. In one example, the value of the lower limit amount L0 may be a fixed value (constant value). In another example, the value of the lower limit amount L0 may be a variable value. A difference between the upper limit amount L1 and the lower limit amount L0 corresponds to the amount of charging of the battery 40 by one driving of the engine 10. The amount of charging per unit time may change in accordance with the remaining amount of energy remaining in the battery 40. For example, when the time required for the charging from the lower limit amount L0 to the upper limit amount L1 is modifiable due to a factor such as differences in the difference (amount of charging per time) between the upper limit amount L1 and the lower limit amount L0, the lower limit amount L0 may also be modifiable, as in the upper limit amount L1. The value of the lower limit amount L0 may be specified as a continuous value or may be specified as a discrete value. In one example, each of the modes PM may further define the value of the lower limit amount L0. As a result, the value of the lower limit amount L0 may also be determined in accordance with the mode selection, as in the upper limit amount L1.

### Type of Hybrid Electric Vehicle

The type of the hybrid electric vehicle V1 may not be particularly limited as long as the internal combustion engine and the battery 40 are included, and may be selected as appropriate according to the embodiment. In one example, the hybrid electric vehicle V1 may include a hybrid electric vehicle (HEV), a plug-in hybrid electric vehicle (PHEV), or the like. An attribute (size, number of wheels, or the like) of the hybrid electric vehicle V1 may not be particularly limited and may be selected as appropriate according to the embodiment. The hybrid electric vehicle V1 may include a manually driven vehicle and an autonomous driving vehicle.

### Operation Example

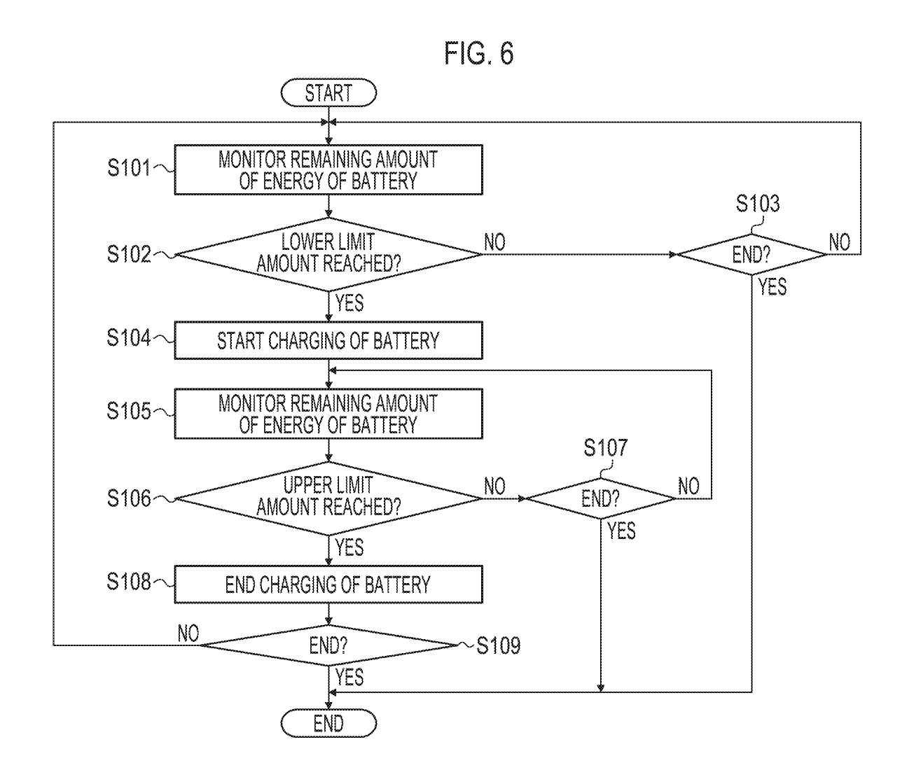

FIG. 5 is a flowchart illustrating an example of a processing procedure related to the setting of the upper limit amount L1 by the control device 60 according to the present embodiment. FIG. 6 is a flowchart illustrating an example of a processing procedure related to the external power supply in the HV power supply mode by the control device 60 according to the present embodiment. The processor 601 of the control device 60 executes a command included in a program stored in the memory 602. As a result, the control device 60 operates as a computer capable of executing the information processing of FIGS. 5 and 6. The following processing procedure is an example of an information processing method executed by a computer (control device 60). However, the following processing procedure is merely an example, and each step may be modified as much as possible. For the following processing procedure, a step may be omitted, replaced, or added as appropriate according to the embodiment. In addition, the following operation of the control device 60 may be interpreted as an operation of the processor 601.

### Setting of Upper Limit Amount

The control device 60 may start the execution of the processing procedure related to the setting of the upper limit amount L1 of FIG. 5 at any timing. For example, the control device 60 may start the execution of the processing procedure related to the setting of the upper limit amount L1 of FIG. 5 in response to the operation of the operation device 70, the operation of the input device, or the like.

In S901, the control device 60 determines the value LV of the upper limit amount L1. A method of specifying the value LV of the upper limit amount L1 may not be particularly limited and may be selected as appropriate according to the embodiment. In one example, the modes PM may be prepared. Each of the modes PM may define the value LV of the upper limit amount L1. The modes PM may include a first mode M1 and a second mode M2. The second mode M2 may be defined such that the value LV of the upper limit amount L1 is higher than the value LV of the upper limit amount L1 in the first mode M1. The control device 60 may determine the value LV of the upper limit amount L1 by selecting one mode (drive mode DM) from among the modes PM.

In addition, a method of determining the value LV of the upper limit amount L1 may not be particularly limited and may be selected as appropriate according to the embodiment. In one example, the control device 60 may receive the instruction 81 from the user Z1 and may determine the value LV of the upper limit amount L1 in response to the received instruction 81 from the user Z1. The instruction 81 from the user Z1 may be received via the input device (the touch panel 75, the operator 76, or the like), the user terminal U1, or the like. In another example, the control device 60 may receive the specific operation 83 via the operation device 70 provided in the hybrid electric vehicle V1 and may determine the value LV of the upper limit amount L1 in response to the received specific operation 83. In another example, the control device 60 may acquire the position information 85 of the hybrid electric vehicle V1 and may determine the value LV of the upper limit amount L1 in accordance with the position information 85 that is acquired. For example, when the current position indicated by the position information 85 belongs to the first region where the quietness is required, the control device 60 may determine the value LV of the upper limit amount L1 to be a small value. When the current position belongs to the second region where the quietness is not required, the control device 60 may determine the value LV of the upper limit amount L1 to be a large value. In another example, the control device 60 may determine the value LV of the upper limit amount L1 in accordance with the external power supply connector 87 that is used for connection with the external device E1 from among the external power supply connectors 55. For example, the external power supply connectors 55 may include a first connector provided outside the hybrid electric vehicle V1 and a second connector provided inside the hybrid electric vehicle V1. The control device 60 may determine the value LV of the upper limit amount L1 to be a large value in accordance with the use of the first connector. The control device 60 may determine the value LV of the upper limit amount L1 to be a small value in accordance with the use of the second connector. In another example, the control device 60 may determine the value LV of the upper limit amount L1 in accordance with at least one of the type of the external device E1 and the method of connecting to the external device E1. When the value LV of the upper limit amount L1 is determined, the control device 60 proceeds to the next S902.

In S902, the control device 60 sets the upper limit amount L1 to the value LV that is determined. This setting processing may be configured as appropriate to set the control device 60 to a state of stopping the charging of the battery 40 at the value LV that is set during the external power supply in the HV power supply mode. In one example, when the embodiment in which the value LV of the upper limit amount L1 is determined by selecting the mode is adopted, the control device 60 may set the upper limit amount L1 to the value LV defined in the mode that is selected (drive mode DM). When the setting of the upper limit amount L1 is completed, the control device 60 ends the processing procedure related to the setting of the upper limit amount L1 according to the present operation example.

### Information Processing During External Power Supply

The control device 60 may start the execution of the processing procedure of FIG. 6 at any timing when the external power supply is being executed in the HV power supply mode. In one example, the control device 60 may start the execution of the processing procedure of FIG. 6 along with the start of the execution of the external power supply in the HV power supply mode. The external power supply may be executed at any timing. In one example, the control device 60 may start the execution of the external power supply from the battery 40 to the external device E1 in response to the establishment of a predetermined operating condition. In addition, when the power supply modes are prepared, the power supply mode to be used may be selected as appropriate from among the power supply modes. When the HV power supply mode is selected, the control device 60 may start the execution of the processing procedure of FIG. 6.

In S101, the control device 60 monitors the remaining amount of energy of the battery 40 while the electric power of the battery 40 is being supplied to the external device E1 via the external power supply connector 55.

In S102, the control device 60 determines whether the remaining amount of energy of the battery 40 has reached the lower limit amount L0 in accordance with the result of the monitoring. The value of the lower limit amount L0 may be stored in the memory 602 (in a program or the like) as appropriate and may be referred to as appropriate when the external power supply is executed. When it is determined that the remaining amount of energy of the battery 40 has not reached the lower limit amount L0, the control device 60 proceeds to the next S103. On the other hand, when it is determined that the remaining amount of energy of the battery 40 has reached the lower limit amount L0, the control device 60 proceeds to the next S104.

In S103, the control device 60 determines whether to end the processing. The determination criterion may be optionally set. In one example, the control device 60 may determine not to end the processing until the execution of the external power supply is stopped. On the other hand, when the execution of the external power supply is stopped, the control device 60 may determine to end the processing.

When it is determined not to end the processing, the control device 60 returns to S101 and executes the processing again from S101. As a result, the control device 60 may continuously monitor the remaining amount of energy of the battery 40 while the electric power of the battery 40 is being supplied to the external device E1 via the external power supply connector 55. On the other hand, when it is determined to end the processing, the control device 60 ends the processing procedure related to the external power supply according to the present operation example. The timing at which the processing is ended may not be limited to such an example. The control device 60 may end the execution of the processing procedure related to the external power supply at any timing.

In S104, the control device 60 starts the charging of the battery 40 by driving the engine 10 to cause the motor 30 to generate the electricity, in accordance with the result of the monitoring indicating that the remaining amount of energy of the battery 40 has reached the lower limit amount L0. The driving conditions of the engine 10 may be stored in the memory 602 (in a program or the like) as appropriate and may be referred to as appropriate when the external power supply is executed. When the embodiment in which the value LV of the upper limit amount L1 is determined by selecting the mode is adopted, the driving conditions of each of the modes PM may be stored in the memory 602 (in a program or the like) as appropriate and may be referred to as appropriate when the external power supply is executed. When the charging of the battery 40 is started, the control device 60 proceeds to the next S105.

In S105, the control device 60 monitors the remaining amount of energy of the battery 40 while the charging continues after the charging of the battery 40 is started by driving the engine 10. The processing of S105 may be the same as the processing of S101, except for the presence or absence of the driving of the engine 10.

In S106, the control device 60 determines whether the remaining amount of energy of the battery 40 has reached the upper limit amount L1 that is set in accordance with the result of the monitoring. The value (value LV) of the upper limit amount L1 may be stored in the memory 602 (in a program or the like) as appropriate and may be referred to as appropriate when the external power supply is executed. In one example, the control device 60 may determine whether the remaining amount of energy of the battery 40 has reached the upper limit amount L1 that is set to the value LV defined in the mode that is selected (drive mode DM). When it is determined that the remaining amount of energy of the battery 40 has not reached the upper limit amount L1 that is set, the control device 60 proceeds to the next S107. On the other hand, when it is determined that the remaining amount of energy of the battery 40 has reached the upper limit amount L1 that is set, the control device 60 proceeds to the next S108.

In S107, the control device 60 determines whether to end the processing. The processing of S107 may be the same as the processing of S103. When it is determined not to end the processing, the control device 60 returns to S105 and executes the processing again from S105. As a result, the control device 60 may continuously monitor the remaining amount of energy of the battery 40 while the charging continues after the charging of the battery 40 is started by driving the engine 10. On the other hand, when it is determined to end the processing, the control device 60 ends the processing procedure related to the external power supply according to the present operation example.

In S108, the control device 60 ends the charging of the battery 40 by stopping the driving of the engine 10, in accordance with the result of the monitoring indicating that the remaining amount of energy of the battery 40 has reached the upper limit amount L1 that is set. When the charging of the battery 40 is ended, the control device 60 proceeds to the next S109.

In S109, the control device 60 determines whether to end the processing. The processing of S109 may be the same as the processing of S103 or the like. When it is determined not to end the processing, the control device 60 returns to S101 and executes the processing again from S101. On the other hand, when it is determined to end the processing, the control device 60 ends the processing procedure related to the external power supply according to the present operation example. The control device 60 may execute the series of processing of S101 to S109 in real time while executing the external power supply.

### Features

In the present embodiment, the value LV of the upper limit amount L1 can be modified by the processing of S901 and S902. By setting the value LV of the upper limit amount L1 to be high, the frequency of repeating the driving and the stopping of the engine 10 in the series of processing of S101 to S109 can be suppressed. On the other hand, by setting the value LV of the upper limit amount L1 to be low, the driving time of the engine 10 in the processing of S104 to S107 can be suppressed. Therefore, according to the present embodiment, by modifying (adjusting) the value LV of the upper limit amount L1, it is possible to execute charging of the battery 40 during the external power supply by switching between prioritizing quietness and prioritizing power supply efficiency.

### Modification

Although the embodiments of the present disclosure have been described in detail above, the above description is merely an example of the present disclosure in every respect. The processing and means described in the present disclosure can be implemented in any combination as long as no technical inconsistencies arise. In the embodiments described above, various improvements or modifications may be made as appropriate. The configuration of the hybrid electric vehicle V1 may not be limited to the example of FIG. 1 and may be modified as appropriate according to the embodiment. Regarding the specific hardware configuration of the hybrid electric vehicle V1, components may be omitted, replaced, or added as appropriate according to the embodiment.

What is claimed is:

1. A hybrid electric vehicle comprising:
an internal combustion engine;
a generator;
a battery;
an external power supply connector; and
a control device, wherein:
the generator is configured to generate electricity using power from the internal combustion engine;
the battery is connected to the generator via an electric power line;
the external power supply connector is configured to supply electric power of the battery to an external device to be connected;
the control device is configured to execute
monitoring a remaining amount of energy of the battery while the electric power of the battery is being supplied to the external device via the external power supply connector,
starting charging of the battery by driving the internal combustion engine to cause the generator to generate the electricity, in accordance with a result of the monitoring indicating that the remaining amount of the energy of the battery has reached a lower limit amount,
monitoring the remaining amount of the energy of the battery while the charging continues after the charging of the battery is started, and
ending the charging of the battery by stopping the driving of the internal combustion engine, in accordance with a result of the monitoring indicating that the remaining amount of the energy of the battery has reached an upper limit amount that is set; and
the control device is further configured to execute
determining a value of the upper limit amount, and
setting the upper limit amount to the value that is determined.

2. The hybrid electric vehicle according to claim 1, wherein:
the determining of the value of the upper limit amount includes selecting one mode from among a plurality of modes;
each of the modes defines the value of the upper limit amount;
the setting of the upper limit amount to the value that is determined includes setting the upper limit amount to a value defined in the mode that is selected;
the modes include a first mode and a second mode; and
in the second mode, the value of the upper limit amount is defined so as to be higher than the value of the upper limit amount in the first mode.

3. The hybrid electric vehicle according to claim 1, wherein the determining of the value of the upper limit amount includes:
receiving a specific operation via an operation device provided in the hybrid electric vehicle; and
determining the value of the upper limit amount in response to the specific operation.

4. The hybrid electric vehicle according to claim 1, wherein the determining of the value of the upper limit amount includes:
acquiring position information of the hybrid electric vehicle; and
determining the value of the upper limit amount in accordance with the position information that is acquired.

5. The hybrid electric vehicle according to claim 1, further comprising a plurality of the external power supply connectors, wherein the determining of the value of the upper limit amount includes determining the value of the upper limit amount in accordance with the external power supply connector that is used for connection with the external device from among the external power supply connectors.
